(19) United States
(12) Patent Application Publication
(10) Pub. No.: US 2025/0181315 A1
(43) Pub. Date: Jun. 5, 2025

(54) ARITHMETIC DEVICE

(71) Applicant: Sony Group Corporation, Tokyo (JP)

(72) Inventors: Kazuma Michigami, Tokyo (JP); Hiroyuki Katchi, Tokyo (JP)

(21) Appl. No.: 18/840,769

(22) PCT Filed: Mar. 3, 2023
(86) PCT No.: PCT/JP2023/007934

§ 371 Date: Aug. 22, 2024

(30) Foreign Application Priority Data
Mar. 31, 2022 (JP) 2022-060606

(51) Int. Cl. G06F 7/483; G06F 7/544

(52) U.S. Cl. CPC G06F 7/483; G06F 7/5443

(57) ABSTRACT

Arithmetic devices with error prevention in fixed-point number conversion are disclosed. In, one example, a conversion unit converts a signed fixed-point number in a complement notation of 2 in which a most significant digit and a least significant digit are represented by 2^{Mi} and 2^{Li}, respectively, using integers Mi and Li and an unsigned fixed-point number in which a most significant digit and a least significant digit are represented by 2^{Mu} and 2^{Lu}, respectively, using integers Mu and Lu into an extended signed fixed-point number that is a signed fixed-point number in a complement notation of 2 in which a most significant digit and a least significant digit are represented by 2^{M} and 2^{L} using M and L, respectively, that satisfy the following expression M=max (1, max (Mi, Mu+1)) L=min (0, min (Li, Lu)).

### FIELD

The present disclosure relates to an arithmetic device.

### BACKGROUND

A deep neural network (DNN), which is an example of deep learning, has high recognition accuracy. On the other hand, the DNN has a problem that memory consumption, a calculation amount, power consumption, and the like increase. In order to solve this problem, a method of quantizing data used for arithmetic operation processing to a fixed-point number with a small bit width is used.

In a case where an image signal of image data is used as input data of a DNN model or in a case where an activation function such as rectified linear unit (ReLU) is applied, the data does not become a negative number, and thus the value can be efficiently expressed by using an unsigned fixed-point number as the data. A system capable of calculating both the unsigned fixed-point number and a signed fixed-point number has been proposed (see, for example, Patent Literature 1).

In the conventional technique described above, a signed fixed-point number in a complement notation of 2 with an 8-bit width and an unsigned fixed-point number with an 8-bit width are converted into the signed fixed-point number in an absolute value notation with a 9-bit width to perform an operation.

### CITATION LIST

### Patent Literature

Patent Literature 1: JP 2021-528764 A

### SUMMARY

### Technical Problem

However, in the above related art, depending on the decimal point positions of the signed fixed-point number in a complement notation of 2 with an 8-bit width and the unsigned fixed-point number with an 8-bit width, when conversion is performed so that the converted value can express a value of 1, a least significant digit may be reduced. Specifically, in a case where conversion is performed so that the value of 1 can be expressed by the above-described conventional technique, it is necessary to add 2° digits to an absolute value part at the time of conversion. In a case where a least significant digit is insufficient due to the addition of the 2° digits, a least significant digit of the original fixed-point number is reduced. Thus, in the above-described conventional technique, there is a problem that an error in calculation increases. On the other hand, in a case where the value of 1 is not expressed, the product-sum operator of the neural network circuit cannot be used as an adder, and convenience is deteriorated.

Therefore, the present disclosure proposes an arithmetic device that prevents an error from occurring when a signed fixed-point number and an unsigned fixed-point number are converted into a common fixed-point number.

### Solution to Problem

An arithmetic device according to the present disclosure includes: a conversion unit that converts a signed fixed-point number in a complement notation of 2 in which a most significant digit and a least significant digit are represented by 2^{M} and 2^{L}, respectively, using integers Mi and Li and an unsigned fixed-point number in which a most significant digit and a least significant digit are represented by 2^{Mu} and 2^{Lu}, respectively, using integers Mu and Lu into an extended signed fixed-point number that is a signed fixed-point number in a complement notation of 2 in which a most significant digit and a least significant digit are represented by 2^{M} and 2^{Lu} using M and L, respectively, that satisfy M=max (1, max (Mi, Mu+1)): max ( ) representing a largest element in parentheses, and L=min (0, min (Li, Lu)): min ( ) representing a smallest element in parentheses, in which when the signed fixed-point number is converted into the extended signed fixed-point number, sign extension of the signed fixed-point number is performed on a significant digit of the extended signed fixed-point number corresponding to an insufficient digit in the signed fixed-point number, and a value of 0 is substituted for a less significant digit of the extended signed fixed-point number corresponding to an insufficient digit in the signed fixed-point number, and when the unsigned fixed-point number is converted into the extended signed fixed-point number, a value of 0 is substituted into a significant digit of the extended signed fixed-point number corresponding to an insufficient digit in the unsigned fixed-point number, and a value of 0 is substituted into a less significant digit of the extended signed fixed-point number corresponding to an insufficient digit in the unsigned fixed-point number; and a product-sum operator that performs a product-sum operation of the converted extended signed fixed-point number.

### BRIEF DESCRIPTION OF DRAWINGS

FIG. 1 is a diagram illustrating a configuration example of a neural network circuit according to an embodiment of the present disclosure.

FIG. 2 is a diagram illustrating a configuration example of an arithmetic unit according to a first embodiment of the present disclosure.

FIG. 3A is a diagram illustrating an example of conversion according to the embodiment of the present disclosure.

FIG. 3B is a diagram illustrating an example of conversion according to the embodiment of the present disclosure.

FIG. 3C is a diagram illustrating an example of conversion according to the embodiment of the present disclosure.

FIG. 4A is a diagram illustrating an example of conversion according to the embodiment of the present disclosure.

FIG. 4B is a diagram illustrating an example of conversion according to the embodiment of the present disclosure.

FIG. 5A is a diagram illustrating an example of conversion according to a conventional technique.

FIG. 5B is a diagram illustrating an example of conversion according to the conventional technique.

FIG. 5C is a diagram illustrating an example of conversion according to the conventional technique.

FIG. 5D is a diagram illustrating an example of conversion according to the conventional technique.

FIG. 6 is a diagram illustrating an example of a processing procedure of arithmetic operation processing according to the first embodiment of the present disclosure.

FIG. 7 is a diagram illustrating an example of a processing procedure of conversion processing according to the first embodiment of the present disclosure.

FIG. 8 is a diagram illustrating an example of a processing procedure of a product-sum operation according to the first embodiment of the present disclosure.

FIG. 9 is a diagram illustrating an example of a processing procedure of data input processing according to the first embodiment of the present disclosure.

FIG. 10 is a diagram illustrating an example of another processing procedure of product-sum operation processing according to the first embodiment of the present disclosure.

FIG. 11 is a diagram illustrating a configuration example of an arithmetic unit according to a second embodiment of the present disclosure.

### DESCRIPTION OF EMBODIMENTS

Hereinafter, an embodiment of the present disclosure will be described in detail with reference to the drawings. The description will be given in the following order. Note that in each of the following embodiments, the same parts are denoted by the same reference numerals, and redundant description will be omitted.
1. First Embodiment
2. Second Embodiment

### 1. First Embodiment

### [Configuration of Neural Network Circuit]

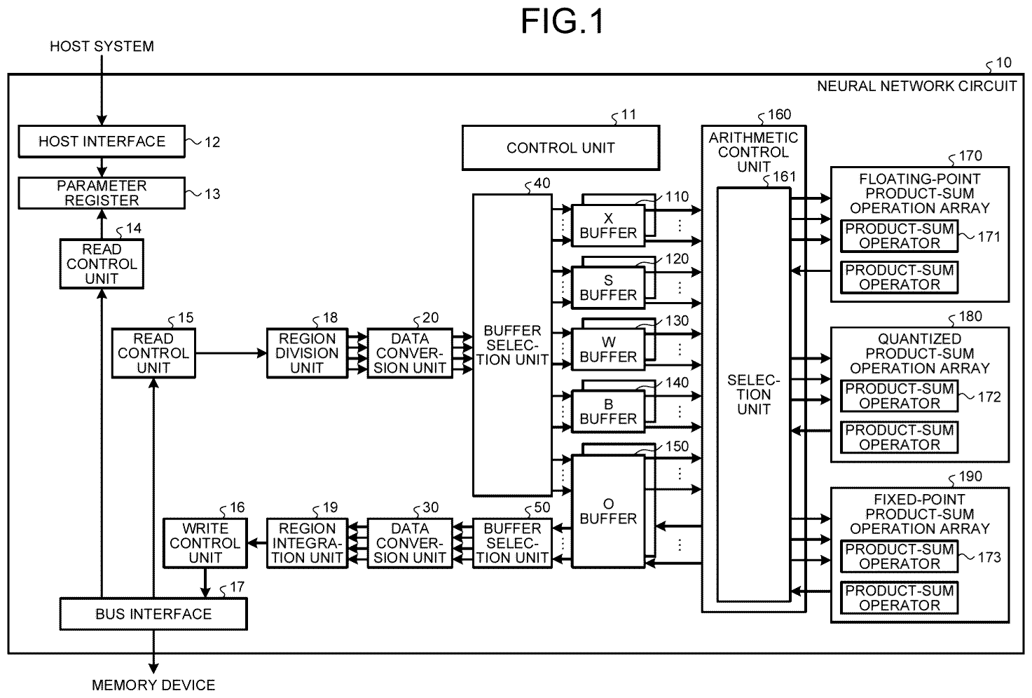

FIG. 1 is a diagram illustrating a configuration example of a neural network circuit according to an embodiment of the present disclosure. The drawing is a block diagram illustrating a configuration example of a neural network circuit 10 to which the arithmetic device of the present disclosure is applied. The neural network circuit 10 is a circuit that performs an operation related to DNN such as a convolution operation or an average pooling operation. The neural network circuit 10 performs a process of calculating data read from a memory device and writing an operation result to the memory device. As the data processed by the neural network circuit 10, for example, data having a multi-dimensional array structure such as image data is assumed.

The neural network circuit 10 includes a control unit 11, a host interface 12, a parameter register 13, read control units 14 and 15, a write control unit 16, a bus interface 17, a region division unit 18, and a region integration unit 19. The neural network circuit 10 further includes data conversion units 20 and 30, buffer selection units 40 and 50, an X buffer 110, an S buffer 120, a W buffer 130, a B buffer 140, an O buffer 150, and an arithmetic control unit 160. The neural network circuit 10 further includes a floating-point product-sum operation array 170, a quantized product-sum operation array 180, and a fixed-point product-sum operation array 190.

The control unit 11 controls the entire neural network circuit 10. The control unit 11 performs control on the basis of a parameter held in a parameter register 13 described later. The control unit 11 can be configured by, for example, a central processing unit (CPU), a microcomputer, or a state machine circuit.

The host interface 12 exchanges data with the host system. The bus interface 17 exchanges data with a memory device via a bus.

The parameter register 13 holds parameters in operation. Parameters are input to the parameter register 13 from the memory device and the host system.

The read control unit 14 and the read control unit 15 perform control to read data from the memory device. The read control unit 14 outputs the read data to the parameter register 13. The read control unit 15 outputs the read data to the region division unit 18. The region division unit 18 divides input data.

The region division unit 18 divides the input data having a read width defined by the bus interface 17 into a minimum width when the input data is stored in the X buffer 110 or the like. For example, the region division unit 18 can divide the 32-bit input data into four 8-bit data. The region division unit 18 outputs the divided data to the data conversion unit 20.

The data conversion unit 20 converts a data format. The data conversion unit 20 converts the input data into a format applied in the product-sum operation in the subsequent stage.

The buffer selection unit 40 selects an X buffer 110, an S buffer 120, a W buffer 130, a B buffer 140, and an O buffer 150 to be described later, and inputs data from the data conversion unit 20 to an appropriate position of the selected buffer.

The X buffer 110 holds data to be subjected to a convolution operation. It is also possible to employ a configuration in which a plurality of X buffers 110 is arranged and a buffer for calculation and a buffer for memory access are switched and used.

The S buffer 120 holds data for improving processing efficiency of the arithmetic control unit 160 and the selection unit 161. It is also possible to employ a configuration in which a plurality of S buffers 120 is arranged and a buffer for calculation and a buffer for memory access are switched and used.

The W buffer 130 holds weighting factors in the convolution operation. It is also possible to employ a configuration in which a plurality of W buffers 130 is arranged and a buffer for calculation and a buffer for memory access are switched and used.

The B buffer 140 holds a bias value in the convolution operation. It is also possible to employ a configuration in which a plurality of B buffers 140 is arranged and a buffer for calculation and a buffer for memory access are switched and used.

The X buffer 110, the S buffer 120, the W buffer 130, and the B buffer 140 can be constituted by semiconductor memories.

The arithmetic control unit 160 controls input and output of product-sum operation. The arithmetic control unit 160 includes a selection unit 161. The selection unit 161 selects the X buffer 110, the S buffer 120, the W buffer 130, the B buffer 140, and the O buffer 150, and reads data from the selected X buffer 110 or the like. Further, the selection unit 161 selects any one of the floating-point product-sum operation array 170, the quantized product-sum operation array 180, and the fixed-point product-sum operation array 190, and inputs data from the X buffer 110 or the like. Further, the selection unit 161 acquires the operation result from the selected floating-point product-sum operation array 170 or the like, and outputs an operation result to the O buffer 150.

The floating-point product-sum operation array 170 is configured by arranging a plurality of product-sum operators 171 that perform product-sum operations of floating-point numbers. A plurality of product-sum operators 171 is arranged in the floating-point product-sum operation array 170 in the drawing. As the product-sum operator 171, for example, a product-sum operator that performs a product-sum operation using a 16-bit half-precision floating-point number can be applied.

The quantized product-sum operation array 180 is configured by arranging a plurality of product-sum operators 172 that perform quantized product-sum operations.

The fixed-point product-sum operation array 190 is configured by arranging a plurality of product-sum operators 173 that perform a product-sum operation of a fixed-point number.

The O buffer 150 holds the result of the product-sum operation. The O buffer 150 outputs the held data to the buffer selection unit 50. It is also possible to employ a configuration in which a plurality of O buffers 150 is arranged and a buffer for calculation and a buffer for memory access are switched and used. The O buffer 150 can include a semiconductor memory.

The buffer selection unit 50 selects some data from the data held by the O buffer 150 and outputs the selected data to the data conversion unit 30.

The data conversion unit 30 converts the operation result of product-sum calculation into the format of the original data. The data conversion unit 30 outputs the converted data to the region integration unit 19.

The region integration unit 19 integrates the data divided by the region division unit 18. The region integration unit 19 outputs the integrated data to the write control unit 16.

The write control unit 16 writes the data output from the region integration unit 19 in the memory device. The write control unit 16 writes data via the bus interface 17.

In the neural network circuit 10 described above, the data conversion unit 20 converts the signed fixed-point number and the unsigned fixed-point number. This conversion will be described in detail.

### [Configuration of Arithmetic Unit]

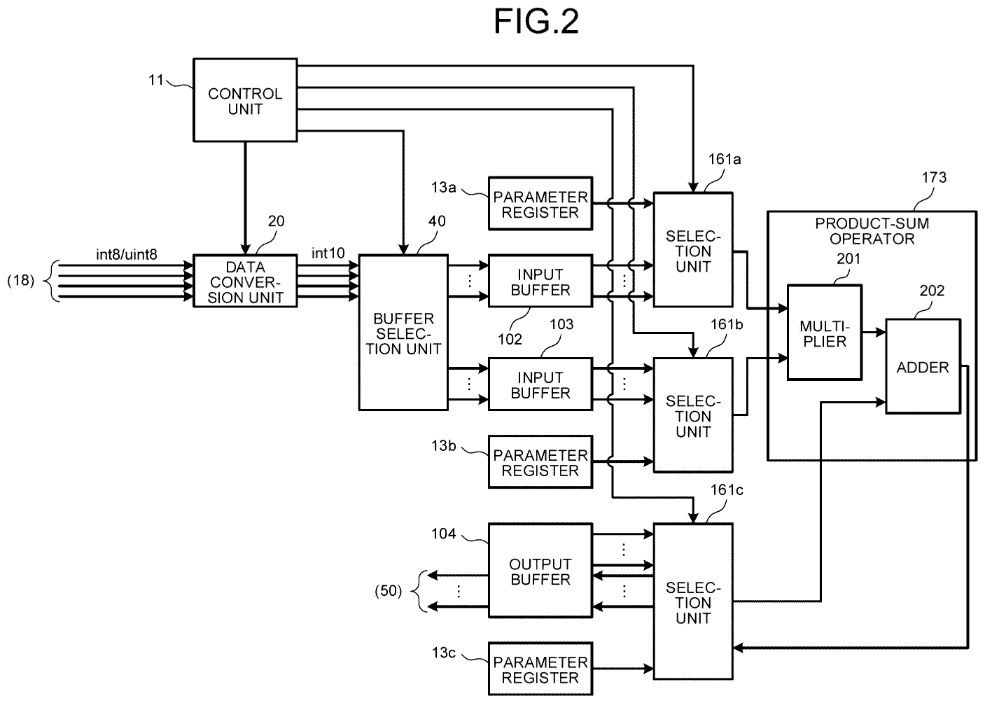

FIG. 2 is a diagram illustrating a configuration example of an arithmetic unit according to the first embodiment of the present disclosure. The drawing is a block diagram of an arithmetic unit representing a portion that performs a convolution operation and the like in the neural network circuit 10. The arithmetic unit in the drawing includes the data conversion unit 20, input buffers 102 and 103, parameter registers 13a, 13b, and 13c, selection units 161a, 161b, and 161c, a product-sum operator 173, an output buffer 104, and the control unit 11. Note that the parameter registers 13a, 13b, and 13c in the drawing are illustrated by dividing the parameter register 13 in FIG. 1 into three. Further, the selection units 161a, 161b, and 161c in the drawing are illustrated by dividing the selection unit 161 in FIG. 1 into three regions. Furthermore, the input buffers 102 and 103 are buffers corresponding to the X buffer 110 and the W buffer 130 in FIG. 1. Further, the output buffer 104 is a buffer corresponding to the O buffer 150 in FIG. 1.

Further, in the drawing, “int” represents a signed fixed-point number in a complement notation of 2. Furthermore, “uint” represents an unsigned fixed-point number. The numbers following “int” and “uint” represent bit widths. int8 in the drawing represents a signed fixed-point number in a complement notation of 2 with an 8-bit width. uint8 in the drawing represents an unsigned fixed-point number with an 8-bit width.

The data conversion unit 20 converts the signed fixed-point number in a complement notation of 2 and the unsigned fixed-point number into an extended signed fixed-point number that is a common display method. The extended signed fixed-point number is a signed fixed-point number in a complement notation of 2, and is obtained by extending the bit widths of the signed fixed-point number and the unsigned fixed-point number. “int10” in the drawing represents a 10-bit wide extended signed fixed-point number. The data conversion unit 20 determines the presence or absence of the sign of the input 8-bit wide fixed-point number on the basis of a control signal from the control unit 11, and performs conversion. In addition, the data conversion unit 20 outputs the extended signed fixed-point number of a conversion result to the buffer selection unit 40. The buffer selection unit 40 in the drawing inputs the extended signed fixed-point number to an appropriate position of the input buffer 102 or 103 on the basis of a control signal of the control unit 11. Note that the data conversion unit 20 is an example of a “conversion unit” of the present disclosure.

The input buffers 102 and 103 are buffers that hold the extended signed fixed-point number converted by the data conversion unit 20. The input buffer 102 outputs the held data of the extended signed fixed-point number to the selection unit 161a. The input buffer 103 outputs the held data of the extended signed fixed-point number to the selection unit 161b. For example, a feature map of the convolution operation is input to the input buffer 102. Furthermore, for example, a weighting factor of a convolution operation is input to the input buffer 103.

The parameter registers 13a and 13b in the drawing hold and output the extended signed fixed-point number input to the product-sum operator 173. The extended signed fixed-point number output from the parameter register 13a or the like is a number input to the product-sum operator 173 when addition using the product-sum operator 173 described later is performed. For example, a value of 1 can be applied to this number. In a case where int8 and uint8 are decimal point positions that cannot express the value of 1, the extended signed fixed-point number converted from int8 and uint8 also does not become the value of 1. The conversion result is written to the input buffer 102 or the like, and thus the value of 1 cannot be input from the input buffer 102 or the like to the product-sum operator 173. Therefore, the value of 1 is output from the parameter register 13a or the like and input to the product-sum operator 173. Thus, the product-sum operator 173 can be used as an adder to be described later.

The parameter register 13c in the drawing holds and outputs the signed fixed-point number input to the product-sum operator 173. The signed fixed-point number output from the parameter register 13c is a number input to the product-sum operator 173 when multiplication using the product-sum operator 173 described later is performed. For example, a value of 0 can be applied to this number.

The selection unit 161a selects one of the input buffer 102 and the parameter register 13a, acquires a value, and inputs the value to the product-sum operator 173. The selection unit 161b selects one of the input buffer 103 and the parameter register 13b, acquires a value, and inputs the value to the product-sum operator 173. The selection unit 161c selects one of the output buffer 104 and the parameter register 13c, acquires a value, and inputs the value to the product-sum operation 173. Further, the selection unit 161c further performs processing of inputting the output from the product-sum operator 173 to an appropriate position of the output buffer 104.

The product-sum operator 173 performs the product-sum operation as described above. This product-sum operation is an operation of sequentially adding multiplication results, and is an operation represented by the following formula.

$$A \times B + C \to C \qquad ( 1 )$$

As illustrated in the drawing, the product-sum operator 173 includes a multiplier 201 and an adder 202. The multiplier 201 multiplies two numbers input to the product-sum operator 173. The adder 202 adds the number of outputs of the multiplier 201 and the number of outputs of the selection unit 161c. The output buffer 104 in the drawing holds the output of the adder 202. The output buffer 104 holds a value of “C” of Expression (1) that is the result of the product-sum operation.

Note that the product-sum operator 173 can also be used as a multiplier and an adder. In a case of use as a multiplier, a value of 0 is substituted for “C” in Expression (1). Thus, the product-sum operator 173 can perform multiplication by A×B. In a case of use as an adder, a value of 1 is substituted for “A” or “B” in Expression (1). This allows the product-sum operator 173 to add B+C or A+C.

### [Conversion]

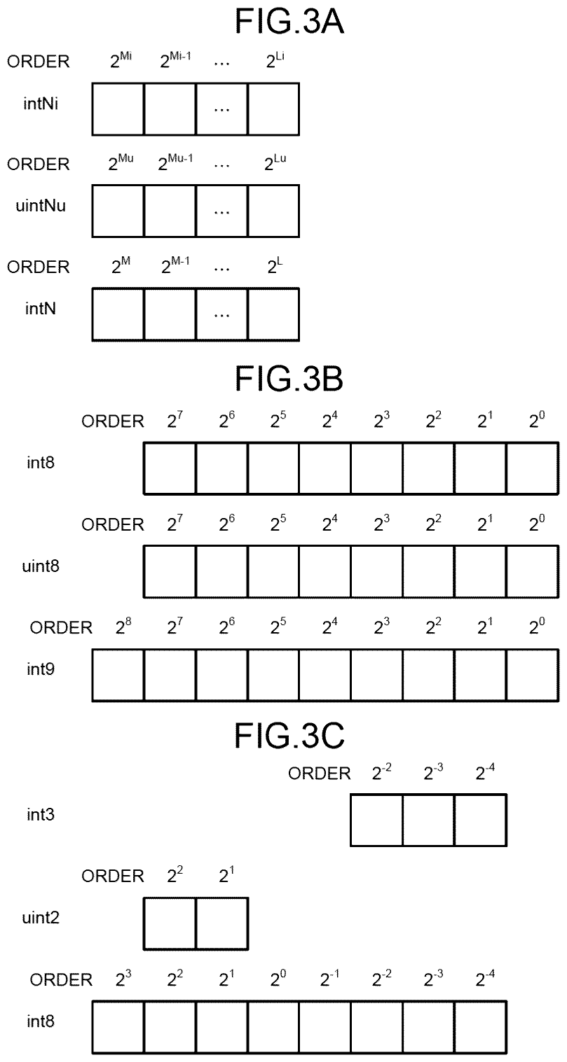

FIGS. 3A to 3C are diagrams illustrating examples of conversion according to an embodiment of the present disclosure. The drawings are diagrams illustrating examples of conversion in the data conversion unit 20. The conversion of the data conversion unit 20 will be described with reference to the drawing.

FIG. 3A illustrates an example of a case where

the signed fixed-point number intNi and the unsigned fixed-point number uintNu are converted into an extended signed fixed-point number intN. Here, Ni, Nu, and N are positive integers representing bit widths. Further, intNi is a signed fixed-point number of a most significant digit 2^{Mi} and a least significant digit 2^{Li}. Also, uintNu is an unsigned fixed-point number of most significant digit 2^{Mu} and a least significant digit 2^{Lu}. These intNi and uintNu are converted to intN. intN is a signed fixed-point number with a most significant digit 2^{M} and a least significant digit 2^{L}. Here, Mi, Mu, M, Li, Lu, and L are integers.

Here, M is a value calculated by the following equation.

$$M = max ( 1 , max ( Mi , Mu + 1 ) ) \qquad ( 2 )$$

However, max ( ) represents a maximum element in parentheses. Further, L is a value calculated by the following equation.

$$L = min ( 0 , min ( Li , Lu ) ) \qquad ( 3 )$$

However, min ( ) represents a smallest element in parentheses.

FIG. 3B illustrates an example of a case where Mi, Li, and Ni convert int8 of a value of 7, a value of 0, and a value of 8, respectively, and Mu, Lu, and Nu convert uint8 of a value of 7, a value of 0, and a value of 8, respectively, into extended signed fixed-point numbers. According to Expression (2), M of the extended signed fixed-point number becomes the value of 8, and according to Expression (3), L becomes a value of 0. Further, from the values of M and L, N is a value of 9. int8 and uint8 are extended to int9 with M, L, and N at the value of 8, the value of 0, and the value of 9, respectively.

FIG. 3C illustrates an example of a case where Mi, Li, and Ni convert int3 of a value of −2, a value of −4, and a value of 3, respectively, and Mu, Lu, and Nu convert uint2 of a value of 2, a value of 1, and a value of 2, respectively, into extended signed fixed-point numbers. According to Expression (2), M of the extended signed fixed-point number becomes the value of 3, and according to Expression (3), L becomes the value of −4. Further, from the values of M and L, N is a value of 8. int3 and uint2 are extended to int8 with M, L, and N at a value of 3, a value of −4, and a value of 8, respectively.

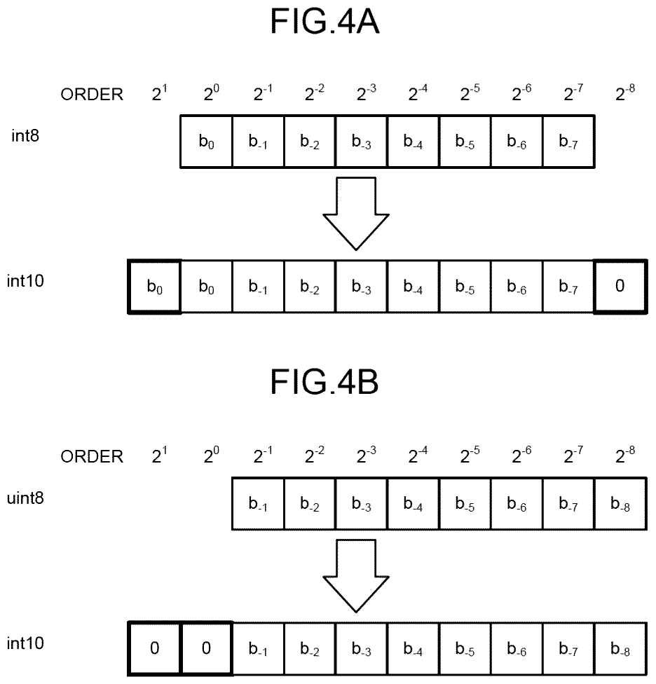

Extension of the bit width for conversion to intN described above causes insufficient digits (orders) in the original intNi and uintNu. When intNi is converted into intN, sign extension of intNi is performed on a significant digit of intN corresponding to a digit of intNi that is insufficient. Further, the value of 0 is substituted into a less significant digit of intN corresponding to the digit of intNi that is insufficient. Also, when uintNu is converted into intN, the value of 0 is substituted into a significant digit of intN in which uintNu is insufficient. Further, the value of 0 is substituted into a less significant digit of intN corresponding to the digit of uintNu that is insufficient. This state will be described with reference to FIGS. 4A and 4B.

FIGS. 4A and 4B are diagrams illustrating examples of conversion according to the embodiment of the present disclosure. The drawings illustrate examples of a case where int8 and uint8 are converted. In int8, Mi and Li are a value of 0 and a value of −7, respectively, and Mu and Lu are a value of −1 and a value of −8, respectively, and thus, in uint8, M and L are a value of 1 and a value of −8, respectively, according to the Expressions (2) and (3). int8 and uint8 are converted to int10 of 10-bit width. In the drawing, bi represents a bit value in the order of 2ⁱ before conversion. This bit value is a value of 0 or a value of 1.

FIG. 4A illustrates an example of a case where int8 is converted. b₀ of int8 is sign extended, and a value at the order of 2¹ of int10 after conversion becomes b₀. In addition, a value of the order of 2⁻⁸ after conversion is 0.

FIG. 4B illustrates an example of a case where uint8 is converted. 2¹ and 2⁰ of int10 after the conversion become the value of 0.

As described above, intNi and uintNu can be converted into the extended signed fixed-point number intN in the unified format. Both intNi and uintNu operations can be performed in a single operation circuit by performing subsequent operations using intN. In addition, since intN after the conversion includes all the numerical bits of intNi and uintNu, it is possible to prevent a decrease in accuracy due to the conversion. Furthermore, it is a signed fixed-point number in a complement notation of 2 including the digits 2¹ and 2⁰, and thus intN can express a value of 1. Thus, the product-sum operator 173 can be used as an adder.

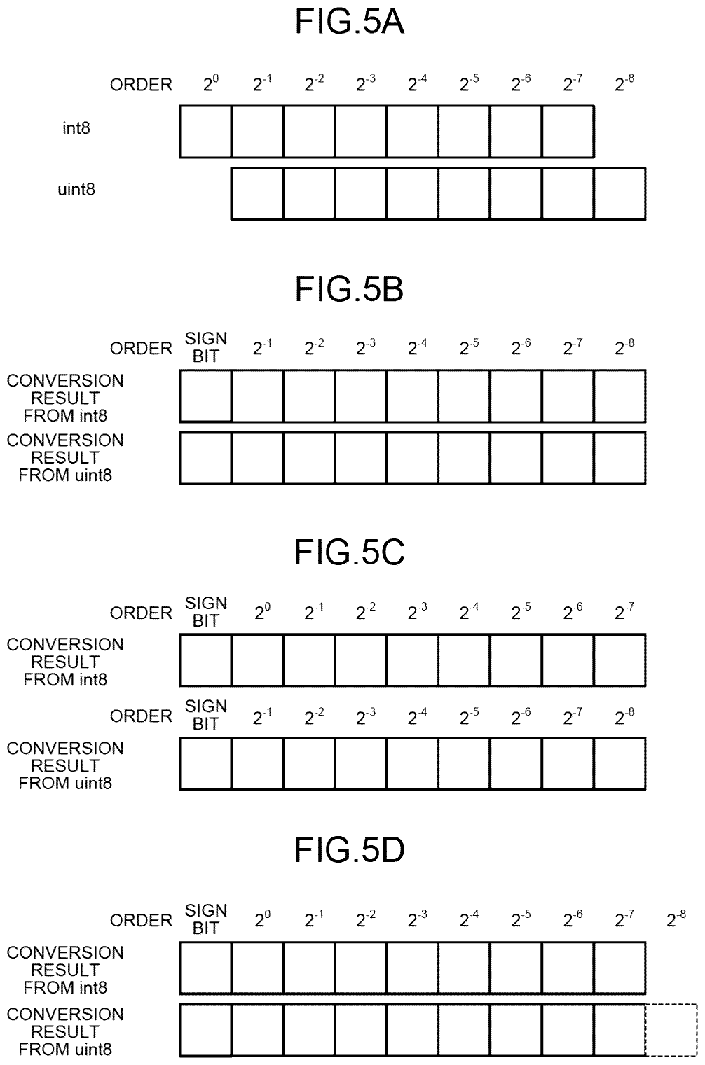

FIGS. 5A to 5D are diagrams illustrating examples of conversion according to a conventional technique. The drawings are diagrams illustrating comparative examples of the conversion of the present disclosure. FIG. 5A illustrates int8 and uint8 before conversion. FIGS. 5B to 5D illustrate examples of converting int8 and uint8 in FIG. 5A into a signed fixed-point number of 9-bit wide absolute value notation of {absolute value of sign bits with an 8-bit width}. In FIGS. 5B to 5D, the upper row represents a signed fixed-point number in an absolute value notation with a 9-bit width converted from int8, and the lower row represents a signed fixed-point number in an absolute value notation with a 9-bit width converted from uint8.

FIG. 5B illustrates an example of a case where a most significant digit of an absolute value part of the signed fixed-point number in an absolute value notation with a 9-bit width is 2⁻¹ and a least significant digit is 2⁻⁸. In this way, it is not possible to accurately convert when int8 is the value of −1. In addition, there is a problem that the value of 1 cannot be expressed by the signed fixed-point number in the absolute value notation of this format.

FIG. 5C illustrates an example of a case where the most significant digit and the least significant digit of the absolute value part of the signed fixed-point number in the absolute value notation of a 9-bit width converted from int8 are set to 2⁰ and 2⁻⁷, respectively, and the most significant digit and the least significant digit of the absolute value part of the signed fixed-point number in the absolute value notation of a 9-bit width converted from uint8 are set to 2⁻¹ and 2⁻⁸, respectively. In this example, the format is different between the case of conversion from int8 and the case of conversion from uint8. The circuit after conversion needs to support two types of formats, which complicates the circuit and control.

FIG. 5D illustrates an example of a case where the most significant digit and the least significant digit of the absolute value part of the signed fixed-point number in the absolute value notation of a 9-bit width are 2⁰ and 2⁻⁷, respectively. In this example, there is a problem that a value of 2⁻⁸ digits of uint8 is truncated when converted from uint8, and an error occurs in the conversion.

The data conversion unit 20 of the embodiment of the present disclosure can perform conversion without causing the problem of FIGS. 5B to 5D described above. That is, the value of 1 can be expressed in the format after conversion, and no error occurs at the time of conversion.

### [Arithmetic Operation Processing]

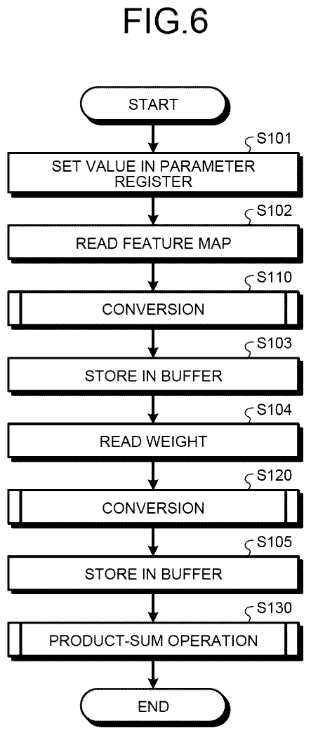

FIG. 6 is a diagram illustrating an example of a processing procedure of arithmetic operation processing according to the first embodiment of the present disclosure. The drawing is a flowchart illustrating an example of an operation in the neural network circuit 10. First, the control unit 11 sets a value in the parameter register 13 (step S101). This can be performed by causing the parameter register 13 to hold a set value read from the memory device. Next, the control unit 11 reads the feature map from the memory device (step S102). Next, the data conversion unit 20 performs conversion processing (step S110) of the read feature map to convert the feature map into a unified format. Next, the control unit 11 stores the converted feature map in the buffer (input buffer 102) (step S103).

Next, the control unit 11 reads a weight from the memory device (step S104). Next, the data conversion unit 20 performs conversion processing (step S120) of the read weight to convert the weight into the unified format. Next, the control unit 11 stores the converted weight in the buffer (input buffer 103) (step S105). Next, the control unit 11 performs product-sum operation (step S130) and ends the processing.

### [Conversion Processing]

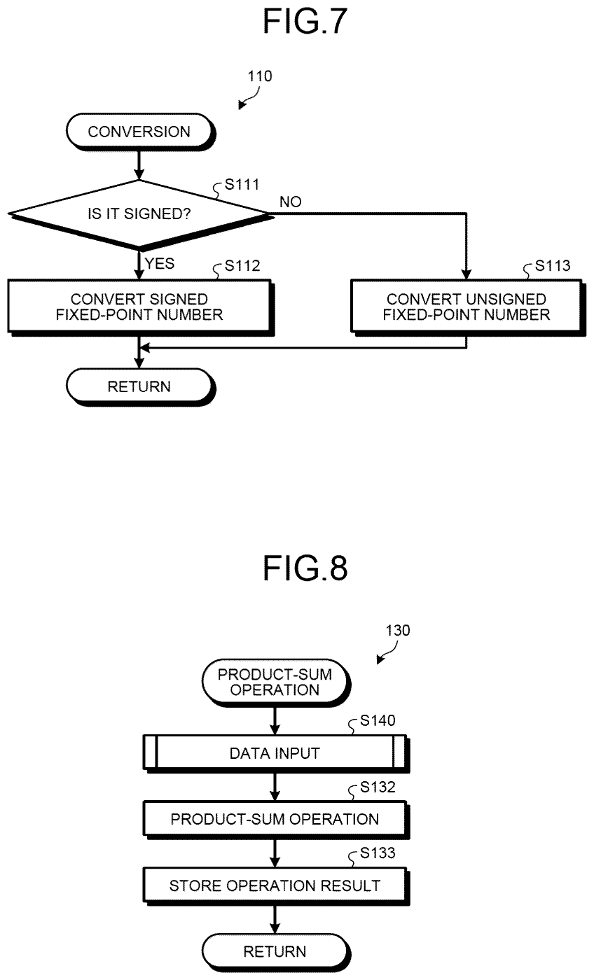

FIG. 7 is a diagram illustrating an example of a processing procedure of the conversion processing according to the first embodiment of the present disclosure. The processing in the drawing is a flowchart illustrating the conversion processing (step S110) in FIG. 6. Note that the conversion processing in FIG. 6 (step S120) is also similar to the conversion processing in the drawing.

First, the control unit 11 determines whether or not the conversion target is signed (step S111). As a result, in a case where the conversion target is signed (step S111, Yes), the control unit 11 controls the data conversion unit 20 to convert the signed fixed-point number (step S112). On the other hand, in a case where the conversion target is not signed (step S111, No), the control unit 11 controls the data conversion unit 20 to convert the unsigned fixed-point number (step S113). Thereafter, the control unit 11 returns to the original processing.

### [Product-Sum Operation Processing]

FIG. 8 is a diagram illustrating an example of a processing procedure of product-sum operation processing according to the first embodiment of the present disclosure. The processing in the drawing is a flowchart illustrating the product-sum operation processing (step S130) in FIG. 6. First, the control unit 11 performs data input processing (step S140) to input data to the product-sum operator 173. Next, the product-sum operator 173 performs a product-sum operation (step S132). Next, the control unit 11 stores an operation result (step S133). This can be performed by causing the output buffer 104 to hold the operation result. Thereafter, the control unit 11 returns to the original processing.

### [Data Input Processing]

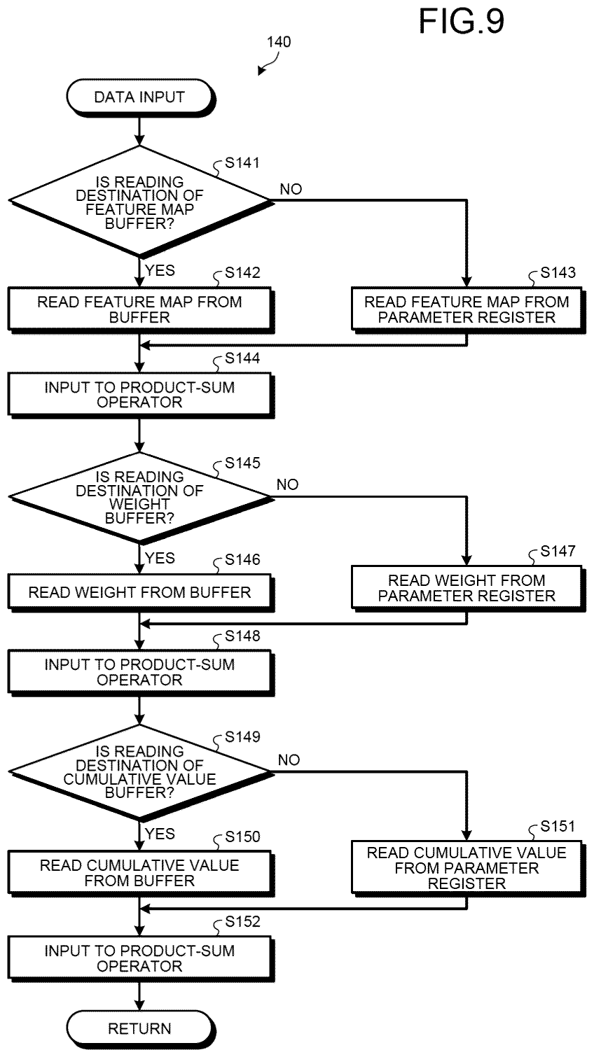

FIG. 9 is a diagram illustrating an example of a processing procedure of data input processing according to the first embodiment of the present disclosure. The processing in the drawing is a flowchart illustrating the data input processing (step S140) in FIG. 8. First, the control unit 11 determines whether or not a reading destination of the feature map is a buffer (step S141). As a result, in a case where the reading destination of the feature map is a buffer (step S141, Yes), the control unit 11 reads the feature map from the buffer (input buffer 102) (step S142) and inputs the feature map to the product-sum operator 173 (step S144). Thereafter, the control unit 11 proceeds to the processing of step S145.

On the other hand, in a case where the reading destination of the feature map is not a buffer in the processing of step S141 (step S141, No), the control unit 11 reads the feature map from a register (parameter register 13) (step S143) and inputs the feature map to the product-sum operator 173 (step S144). Thereafter, the control unit 11 proceeds to the processing of step S145.

In step S145, the control unit 11 determines whether or not the reading destination of the weight is a buffer (step S145). As a result, in a case where the reading destination of the weight is a buffer (step S145, Yes), the control unit 11 reads the weight from the buffer (input buffer 103) (step S146) and inputs the weight to the product-sum operator 173 (step S148). Thereafter, the control unit 11 proceeds to the processing of step S149.

On the other hand, in a case where the reading destination of the weight is not a buffer in the processing of step S145 (step S145, No), the control unit 11 reads the feature map from a register (parameter register 13) (step S147) and inputs the feature map to the product-sum operator 173 (step S148). Thereafter, the control unit 11 proceeds to the processing of step S149.

In step S149, the control unit 11 determines whether or not the reading destination of a cumulative value of the product-sum operation is a buffer (step S149). As a result, in a case where the reading destination of the cumulative value is a buffer (step S149, Yes), the control unit 11 reads the cumulative value from the buffer (output buffer 104) (step S150) and inputs the cumulative value to the product-sum operator 173 (step S152). Thereafter, the control unit 11 returns to the original processing.

On the other hand, in a case where the reading destination of the cumulative value is not a buffer in the processing of step S149 (step S149, No), the control unit 11 reads the feature map from the register (parameter register 13) (step S151) and inputs the feature map to the product-sum operator 173 (step S152). Thereafter, the control unit 11 returns to the original processing.

### [Another Product-Sum Operation Processing]

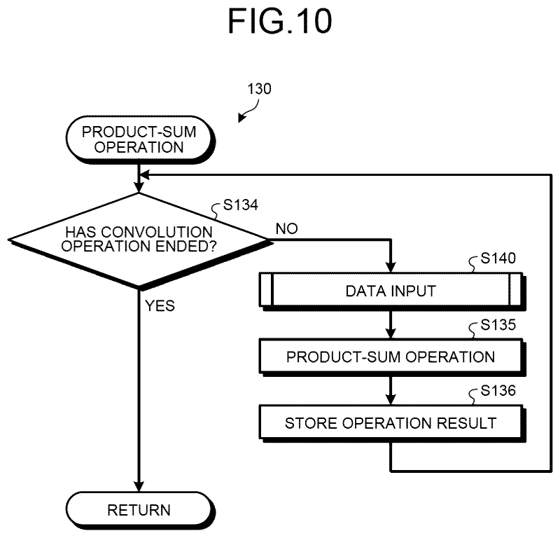

FIG. 10 is a diagram illustrating an example of another processing procedure of the product-sum operation processing according to the first embodiment of the present disclosure. The processing in the drawing is a flowchart illustrating the product-sum operation processing (step S130) when the convolution operation is performed. First, the control unit 11 determines whether the convolution operation has ended (step S134). As a result, when the convolution operation has not been completed (step S134, No), the control unit 11 performs data input processing (step S140) and causes the product-sum operator 173 to perform a product-sum operation (step S135). Next, the control unit 11 stores the operation result (step S136). This can be performed by causing the output buffer 104 to hold the operation result. Thereafter, the control unit 11 returns to the processing of step S134.

In the processing of step S134, when the convolution operation is completed (step S134, Yes), the control unit 11 returns to the original processing.

As described above, the data conversion unit 20 of the first embodiment of the present disclosure converts the signed fixed-point number intNi and the unsigned fixed-point number uintNu into the extended signed fixed-point number intN of the common display scheme. In this conversion, since all bits of intNi and uintNu are reflected in intN, occurrence of an error at the time of conversion can be prevented. Also, intN can represent a value of 1.

### 2. Second Embodiment

The arithmetic unit of the first embodiment described above converts data read from the memory device and stores the converted data in the input buffer 102 or the like. On the other hand, the arithmetic unit of the second embodiment of the present disclosure is different from the above-described first embodiment in that conversion is performed in the middle of inputting data from the input buffer to the product-sum operator 173.

### [Configuration of Arithmetic Unit]

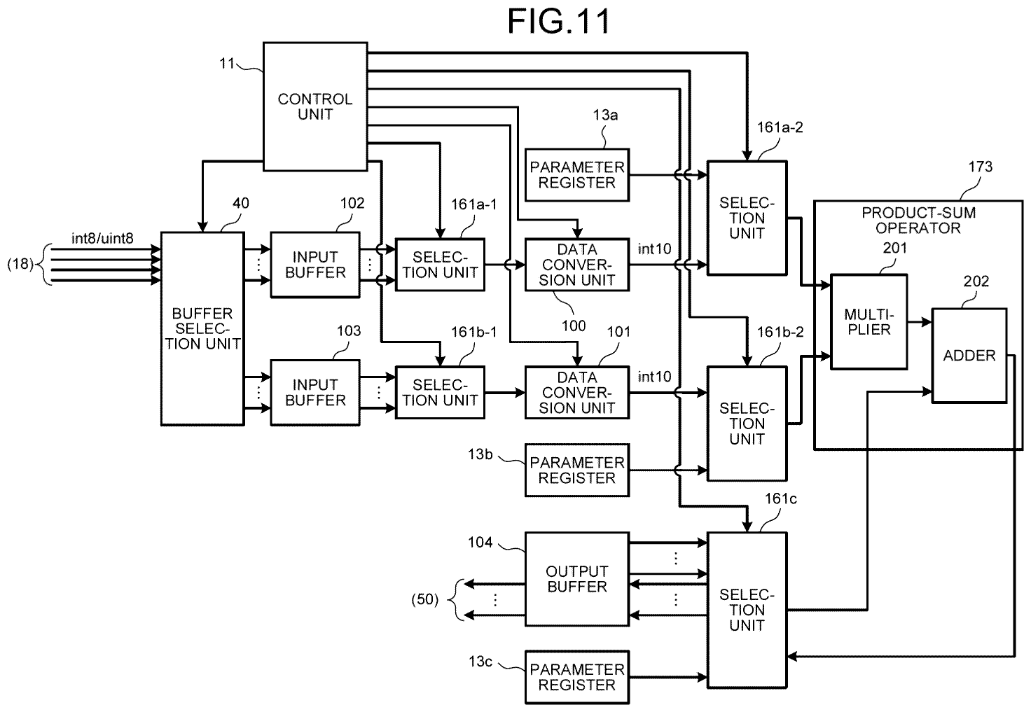

FIG. 11 is a diagram illustrating a configuration example of an arithmetic unit according to the second embodiment of the present disclosure. The drawing, similar to FIG. 2, is a block diagram of an arithmetic unit representing a portion that performs a convolution operation and the like in the neural network circuit 10. The arithmetic unit in the drawing is different from the arithmetic unit in FIG. 2 in including data conversion units 100 and 101 instead of the data conversion unit 20, a selection unit 161a-1 and a selection unit 161a-2 instead of the selection unit 161a, and a selection unit 161b-1 and a selection unit 161b-2 instead of the selection unit 161b.

The selection unit 161a-1 selects any one of a plurality of pieces of data held by the input buffer 102, acquires a value, and inputs the value to the data conversion unit 100. The selection unit 161b-1 selects any one of a plurality of pieces of data held by the input buffer 103, acquires a value, and inputs the value to the data conversion unit 101. The selection units 161a-1 and 161b-1 select data needed for the product-sum operation of the product-sum operator 173 from the input buffers 102 and 103, respectively, that hold a plurality of pieces of data, and acquire the data.

The data conversion unit 100 converts the data output from the selection unit 161a-1 and outputs a conversion result to the selection unit 161a-2. Further, the data conversion unit 101 converts the data output from the selection unit 161b-1 and outputs a conversion result to the selection unit 161b-2.

The selection unit 161a-2 selects one of the number of outputs of the data conversion unit 100 and the number of outputs of the parameter register 13a, acquires a value, and inputs the value to the product-sum operator 173. The selection unit 161b-2 selects one of the number of outputs of the data conversion unit 101 and the number of outputs of the parameter register 13b, acquires a value, and inputs the value to the product-sum operator 173.

In the arithmetic unit in the drawing, the paths from the input buffers 102 and 103 to the product-sum operator 173 are longer than those in the arithmetic unit in FIG. 2, but the bit widths of the input buffers 102 and 103 can be set to 8 bits.

The configuration of the neural network circuit 10 other than this is similar to the configuration of the neural network circuit 10 according to the first embodiment of the present disclosure, and thus the description thereof will be omitted.

Note that the effects described in the present specification are merely examples and are not limited, and other effects may be provided.

Note that the present technology can also have the following configurations.

(1) An Arithmetic Device Comprising:
a conversion unit that converts a signed fixed-point number in a complement notation of 2 in which a most significant digit and a least significant digit are represented by 2^{Mi} and 2^{Li}, respectively, using integers Mi and Li and an unsigned fixed-point number in which a most significant digit and a least significant digit are represented by 2^{Mu} and 2^{Lu}, respectively, using integers Mu and Lu into an extended signed fixed-point number that is a signed fixed-point number in a complement notation of 2 in which a most significant digit and a least significant digit are represented by 2^{M} and 2^{L} using M and L, respectively, that satisfy
M=max (1, max (Mi, Mu+1)): max ( ) representing a largest element in parentheses, and
L=min (0, min (Li, Lu)): min ( ) representing a smallest element in parentheses, in which
when the signed fixed-point number is converted into the extended signed fixed-point number, sign extension of the signed fixed-point number is performed on a significant digit of the extended signed fixed-point number corresponding to an insufficient digit in the signed fixed-point number, and a value of 0 is substituted for a less significant digit of the extended signed fixed-point number corresponding to an insufficient digit in the signed fixed-point number, and
when the unsigned fixed-point number is converted into the extended signed fixed-point number, a value of 0 is substituted into a significant digit of the extended signed fixed-point number corresponding to an insufficient digit in the unsigned fixed-point number, and a value of 0 is substituted into a less significant digit of the extended signed fixed-point number corresponding to an insufficient digit in the unsigned fixed-point number; and
a product-sum operator that performs a product-sum operation of the converted extended signed fixed-point number.

(2) The arithmetic device according to the above (1), further comprising a control unit that controls conversion in the conversion unit.

(3) The arithmetic device according to the above (1) or (2), further comprising
a selection unit that selects either the converted extended signed fixed-point number or a second extended signed fixed-point number, wherein
the product-sum operator performs the product-sum operation on a selection result of the selection unit. (4) The arithmetic device according to any one of the above (1) to (3), further comprising
two of the conversion units, wherein
the product-sum operator performs a product-sum operation of the extended signed fixed-point number from the two of the conversion units.

### REFERENCE SIGNS LIST

10 NEURAL NETWORK CIRCUIT
11 CONTROL UNIT
13, 13a, 13b, 13c PARAMETER REGISTER
20, 100, 101 DATA CONVERSION UNIT
102, 103 INPUT BUFFER
104 OUTPUT BUFFER
161, 161a, 161a-1, 161a-2, 161b, 161b-1, 161b-2, 161c SELECTION UNIT
173 PRODUCT-SUM OPERATOR

1. An arithmetic device comprising:
a conversion unit that converts a signed fixed-point number in a complement notation of 2 in which a most significant digit and a least significant digit are represented by 2^{Mi} and 2^{Li}, respectively, using integers Mi and Li and an unsigned fixed-point number in which a most significant digit and a least significant digit are represented by 2^{Mu} and 2^{Lu}, respectively, using integers Mu and Lu into an extended signed fixed-point number that is a signed fixed-point number in a complement notation of 2 in which a most significant digit and a least significant digit are represented by 2^{M} and 2^{L} using M and L, respectively, that satisfy
M=max (1, max (Mi, Mu+1)): max ( ) representing a largest element in parentheses, and
L=min (0, min (Li, Lu)): min ( ) representing a smallest element in parentheses, in which
when the signed fixed-point number is converted into the extended signed fixed-point number, sign extension of the signed fixed-point number is performed on a significant digit of the extended signed fixed-point number corresponding to an insufficient digit in the signed fixed-point number, and a value of 0 is substituted for a less significant digit of the extended signed fixed-point number corresponding to an insufficient digit in the signed fixed-point number, and
when the unsigned fixed-point number is converted into the extended signed fixed-point number, a value of 0 is substituted into a significant digit of the extended signed fixed-point number corresponding to an insufficient digit in the unsigned fixed-point number, and a value of 0 is substituted into a less significant digit of the extended signed fixed-point number corresponding to an insufficient digit in the unsigned fixed-point number; and
a product-sum operator that performs a product-sum operation of the converted extended signed fixed-point number.

2. The arithmetic device according to claim 1, further comprising a control unit that controls conversion in the conversion unit.

3. The arithmetic device according to claim 1, further comprising
a selection unit that selects either the converted extended signed fixed-point number or a second extended signed fixed-point number, wherein
the product-sum operator performs the product-sum operation on a selection result of the selection unit.

4. The arithmetic device according to claim 1, further comprising
two of the conversion units, wherein
the product-sum operator performs a product-sum operation of the extended signed fixed-point number from the two of the conversion units.
